(19) United States
(12) Patent Application Publication
(10) Pub. No.: US 2017/0286636 A1
(43) Pub. Date: Oct. 5, 2017

(54) VISUAL VERIFICATION OF MEDICATION PACKAGE

(71) Applicant: INTERMETRO INDUSTRIES CORPORATION, Wilkes-Barre, PA (US)

(72) Inventor: Robert Sobie, Wilkes-Barre, PA (US)

(73) Assignee: TOUCHPOINT MEDICAL, INC., Concordville, PA (US)

(21) Appl. No.: 15/512,679

(22) PCT Filed: Sep. 17, 2015
(86) PCT No.: PCT/US15/50651

§ 371 Date: Mar. 20, 2017

Related U.S. Application Data
(60) Provisional application No. 62/052,741, filed on Sep. 19, 2014.

(51) Int. Cl. G06F 19/00

(52) U.S. Cl. CPC G06F 19/3462; G06F 19/321; G06F 19/322

(57) ABSTRACT

A system includes a database that stores information associated with a patient. The information includes information about at least one medication prescribed to the patient. The database stores at least one photograph of a package containing the medication. A control module in communication with the database receives an indication that a healthcare professional has selected the package containing the medication to be administered to the patient and displays the at least one photograph of the package containing the medication. The control module is configured to receive, from the healthcare professional, confirmation that the at least one photograph matches the package containing the medication as selected to be administered to the patient.

### CROSS-REFERENCE TO RELATED APPLICATIONS

This application claims the benefit of U.S. Provisional Application No. 62/052,741, filed on Sep. 19, 2014. The entire disclosure of the application referenced above is incorporated herein by reference.

### FIELD

The present disclosure relates to systems and methods for managing the distribution and administration of pharmaceuticals and medical supplies in a healthcare facility.

### BACKGROUND

This section provides background information related to the present disclosure which is not necessarily prior art.

In a healthcare facility, pharmaceuticals (e.g., medications) and other medical supplies are distributed from a central distribution location (e.g., a central pharmacy) using a medication management system (e.g., a centralized medication management system or a decentralized medication management system). For example, in a centralized medication management system, medications may be provided from the central pharmacy directly to a healthcare professional (e.g., a nurse) that will be administering the medications to respective patients. Conversely, in a decentralized medication management system, multiple medication dispensing sites are located remotely from a centralized distribution location, such as a facility's pharmacy. The remote dispensing sites, such as a nurses' station in a hospital ward, serve as base stations from which healthcare professionals can readily access medications or other medical supplies to be administered to the patients under their care. The decentralized medication management system may implement a decentralized medication dispensing system (MDS), such as an automated dispensing machine (ADM).

One or more medications may be inserted (e.g., at the pharmacy) into a single package and provided to the healthcare professional and/or distributed to the MDS. The healthcare professional removes the package from the MDS (e.g., in a decentralized system) or transports the package from the pharmacy to the patient (e.g., in a centralized system) and administers the medications in the package to the patient according to facility protocols (e.g., according to the well-known “five rights” medication administration protocol).

A critical aspect of the “five rights” medication administration protocol includes verifying that the correct medications are being administered to a specific patient. In a facility, multiple packages may be stored in a single location (e.g., the MDS), and each packet includes medications to be administered to a different patient at a specific day and time. Accordingly, the contents of each of the packages may vary according to orders authorizing medications for the respective patients, and the MDS may store packages for multiple patients and/or multiple packages for a single patient corresponding to different administration times. Different packages may appear similar (e.g., multiple packages may be packaged by a common packager, such as a machine packager).

### SUMMARY

A system includes a database that stores information associated with a patient. The information includes information about at least one medication prescribed to the patient. The database stores at least one photograph of a package containing the medication. A control module in communication with the database receives an indication that a healthcare professional has selected the package containing the medication to be administered to the patient and displays the at least one photograph of the package containing the medication. The control module is configured to receive, from the healthcare professional, confirmation that the at least one photograph matches the package containing the medication as selected to be administered to the patient.

In other features, the at least one photograph includes a photograph of at least two sides of the package containing the medication. The at least one photograph includes a transparent side of the package containing the medication. The system further comprises a packager that automatically captures the at least one photograph upon completing packaging of the medication. The control module displays the at least one photograph in response to receiving the indication. In response to receiving the indication, the control module displays the at least one photograph and prompts the healthcare professional to input confirmation that the at least one photograph matches the package containing the medication as selected to be administered to the patient.

A method includes storing, in a database, information associated with a patient, wherein the information includes information about at least one medication prescribed to the patient, storing, in the database, at least one photograph of a package containing the medication, receiving an indication that a healthcare professional has selected the package containing the medication to be administered to the patient, displaying the at least one photograph of the package containing the medication, and receiving, from the healthcare professional, confirmation that the at least one photograph matches the package containing the medication as selected to be administered to the patient.

In other features, the at least one photograph includes a photograph of at least two sides of the package containing the medication. The at least one photograph includes a transparent side of the package containing the medication. The method further includes automatically capturing the at least one photograph upon completing packaging of the medication. The method further includes displaying the at least one photograph in response to receiving the indication. The method further includes, in response to receiving the indication, displaying the at least one photograph and prompting the healthcare professional to input confirmation that the at least one photograph matches the package containing the medication as selected to be administered to the patient.

A system includes a data storage device that stores information associated with a patient. The information includes information about at least one medication prescribed to the patient, and that stores at least one photograph of a package containing the medication. A mobile workstation is configured to store and/or transport the package containing the medication and includes a control module in communication with the data storage device. The control module receives an indication that a healthcare professional has selected the package containing the medication to be administered to the patient. The mobile workstation displays the at least one photograph of the package containing the medication. The control module is configured to receive, from the healthcare professional, confirmation that the at least one photograph matches the package containing the medication as selected to be administered to the patient.

Further areas of applicability of the present disclosure will become apparent from the detailed description, the claims and the drawings. The detailed description and specific examples are intended for purposes of illustration only and are not intended to limit the scope of the disclosure.

### DRAWINGS

The drawings described herein are for illustrative purposes only of selected embodiments and not all possible implementations, and are not intended to limit the scope of the present disclosure.

FIG. 1 is an example ADM;

FIG. 2 is an example mobile POC workstation;

FIG. 3 is an example medication management system including a medication transportation and verification system according to the principles of the present disclosure;

FIGS. 4A and 4B illustrate display and verification of photographs of a medication package according to the principles of the present disclosure; and

FIG. 5 illustrates an example medication transportation and verification method according to the principles of the present disclosure.

Corresponding reference numerals indicate corresponding parts throughout the several views of the drawings.

### DETAILED DESCRIPTION

Example embodiments will now be described more fully with reference to the accompanying drawings.

In a centralized, decentralized, and/or hybrid medication management system, medications may be packaged (e.g., in individual packages containing one or more medications) and stored (e.g., in a medication base station such as an ADM) to be administered later by a healthcare professional. Machine packagers may create a single package containing multiple medications (e.g., pills) in a single sealed package. The packager may mark the package with a machine-readable and/or human-readable unique identifier associated with the package, information on the contents of the package, information on the patient for whom the package is intended, and information associated with the intended time of administration of the packaged medications. A portion of the information may be stored in a database and associated with the unique identifier marked on the package. Accordingly, each package may include a unique identifier that is machine-readable (e.g., a barcode readable by a scanner) and/or human-readable. The healthcare professional verifies the identifier (e.g., visually via an interface to the database and/or by scanning the barcode) prior to opening the package and administering the medication.

Visual verification of the identifier, which may include comparing the identifier to a matching identifier associated with the patient, may have an associated rate of error. It is possible for a healthcare professional to inadvertently verify a “match” despite the identifier on the package being different than the matching identifier. Conversely, when the package includes a machine-readable identifier, it is also possible for a healthcare professional to inadvertently open the medication package prior to scanning the barcode, thereby disrupting workflow and possibly resulting in waste of the medication.

Systems and methods according to the principles of the present disclosure provide the healthcare professional, at the time of removal and administration of the medication, a visual indication of the appearance of the package associated with a specific patient. In particular_{;} the healthcare professional is provided with a photograph of the specific package including the medication to be administered to the patient. For example, the machine packager may automatically photograph each package upon completing (or during) the packaging of the medication. For example only, the machine packager may include a camera or other image capture device. The photograph may be displayed on a visual interface (e.g., a display of a mobile point-of-care, or POC, workstation) for verification by the healthcare professional. Accordingly, the healthcare professional may verify the visual appearance (e.g., a number, shape, color, etc of the medications in the package) instead of or in addition to verifying the identifier printed on the package.

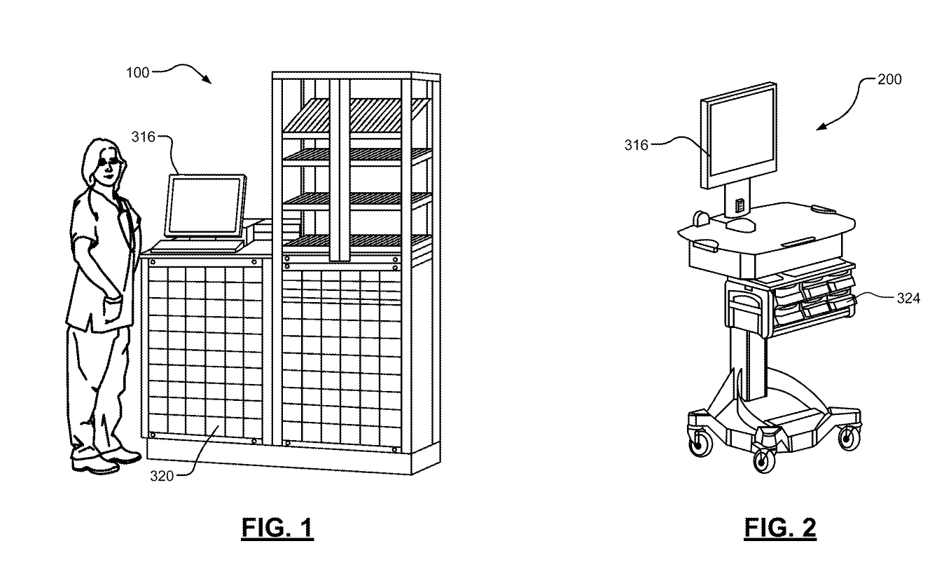

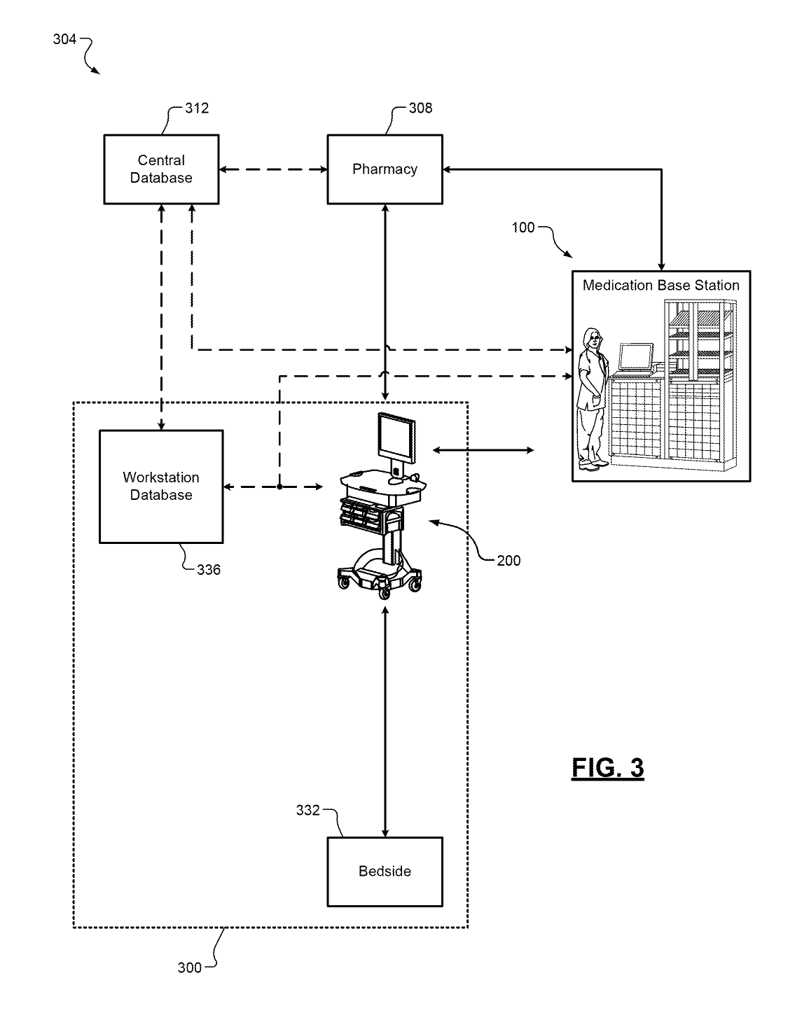

Referring now to FIGS. 1-3, FIGS. 1 and 2 shows an example medication base station 100 and an example medication transportation apparatus, such as a mobile POC workstation 200, respectively. FIG. 3 shows an example medication transportation and verification system 300 according to the principles of the present disclosure operating within a medication management system 304. While the medication management system 304 is described as a decentralized medication management system, the medication transportation and verification system 300 may also be implemented in a centralized medication management system or hybrid medication management system. Accordingly, as described, the example medication management system 304 includes the medication base station 100 and the mobile workstation 200.

In an example implementation, medications are packaged at a central pharmacy 308 and provided to one or more medication base stations 100. A central database 312 may store inventory data about the medications, as well as package specific information (e.g., the unique identifier associated with each package, information on the contents of the package, information on the patient for whom the package is intended, information associated with the intended time of administration of the packaged medications). The central database 312 may also store, with the package specific information, photographs of each package taken upon completing the packaging of the medication(s). For example, the machine packager may photograph one or both sides of each package and store the photographs with the package specific information. For example only, the central database 312 includes a combination of storage devices (e.g., network attached storage), semiconductor and/or magnetic disk-based storage, volatile and/or non-volatile memory, cloud storage, or any other suitable data storage device or system.

At the medication base station 100, the healthcare professional accesses either the mobile POC workstation 200 or the medication base station 100 according to facility protocols (e.g., by utilizing a user access control module (e.g., controller) 316 on one of the workstation 200 or base station 100). The healthcare professional then obtains information related to one or more medications prescribed for a particular patient. Information about medication may be placed in a queue that can be accessed by the control module 316, as appropriate.

In one example implementation, as the healthcare professional approaches the base station 100 with the mobile workstation 200, the base station 100 and the workstation 200 may negotiate a communication link. After the communication link is secured, the base station 100 receives or reads the information in the queue containing the information about medication and prescription information for a given patient. The base station 100 then enables access by the healthcare professional to respective storage locations (e.g., drawers 320) containing the particular medications (i.e., the package containing the medications) for that patient. In some implementations, at the same time the mobile POC workstation 200 may enable access by the healthcare professional to a patient-specific drawer 324 for that patient on the mobile workstation 200.

The healthcare professional retrieves the packaged medications from the drawers 320 of the base station 100 and may record the retrieval activity according to facility protocols. The healthcare professional then places those medications in the patient-specific drawer 324 on the mobile workstation 200 and may record that activity according to facility protocols. These steps are repeated for each of the medications for the patient that are retrieved from the base station 100 and placed in the patient-specific drawer 324 on the mobile workstation 200. The steps may also be repeated for any number of patients under the care of the healthcare professional.

The healthcare professional can thereafter administer the medications to the patient at the patient's bedside 332. For example, the healthcare professional transports the mobile workstation 200 to the patient. At that time, the healthcare professional can access the mobile workstation 200 according to facility protocols utilizing the control module 316 on the workstation 200. The healthcare professional then selects the patient for administration of medications. The control module 316 then enables access by the healthcare professional to the patient-specific drawer 324 containing the packaged medications for that patient.

The healthcare professional then removes the packaged medications from the patient-specific drawer 324 and administers the medications to the patient according to facility protocols (e.g., according to the well-known “five rights” protocol). Further, the medication transportation and verification system 300 according to the principles of the present disclosure provides one or more photographs of each of the packaged medications to the healthcare professional to provide the healthcare professional with a visual confirmation that the packaged medication removed from the patient-specific drawer is the medication correctly associated with the patient.

For example, the photographs of each of the packages may include photographs of one or both sides of the package. The packaging material may be transparent on at least on side of the package to allow the medications in the package to be visible. The photographs and the other package specific information may be stored in the central database 312, and may also be provided to the mobile workstation 200 and/or to the medication base station 100. For example only, while the central database 312 stores the package specific information and photographs as described above, the verification system 300 may optionally include a workstation database 336 that also stores the package specific information and the associated photographs (e.g., as communicated from the central database 312). The information in the workstation database 336 may be provided to (e.g., displayed at) the healthcare professional via the mobile workstation 200 and/or to the medication base station 100. Or, in some implementations, the package specific information and photographs are provided directly from the central database 312 to the mobile workstation 200 and/or to the medication base station 100.

Accordingly, the photographs of the packaged medication to be administered by the healthcare professional are displayed to the healthcare professional, and the healthcare professional may be required to verify that the medication (i.e., the packaged medication removed from the patient-specific drawer 324 or otherwise transported by the healthcare professional to the bedside 332) matches the medication in the photographs. For example, the healthcare professional may be required that each of the medications in the package matches the medications visible inside the package in the photographs. Upon verifying that the medication matches the medication in the photographs, the healthcare professional may indicate that the match was verified (e.g., by responding to a prompt at the control module 316) and proceed with administering the medications to the patient.

Once the medications are administered to the first patient, the healthcare professional can then proceed to successive patients whose medications are contained in the mobile workstation 200, if any. This may include using the control module 316 to record that the medications have been administered.

Either or both of the medication base station 100 and the mobile workstation 200 may be configured to communicate with peripheral devices, such as bar code readers, PDAs, biometric security devices (e.g., a fingerprint scanner), scanners, card readers, keyboards, RFID systems, and the like. The medication base station 100 and/or the mobile workstation 200 (e.g., via respective control modules 316) may implement the operating protocols of the healthcare facility for managing the distribution of medications from a pharmacy to a patient.

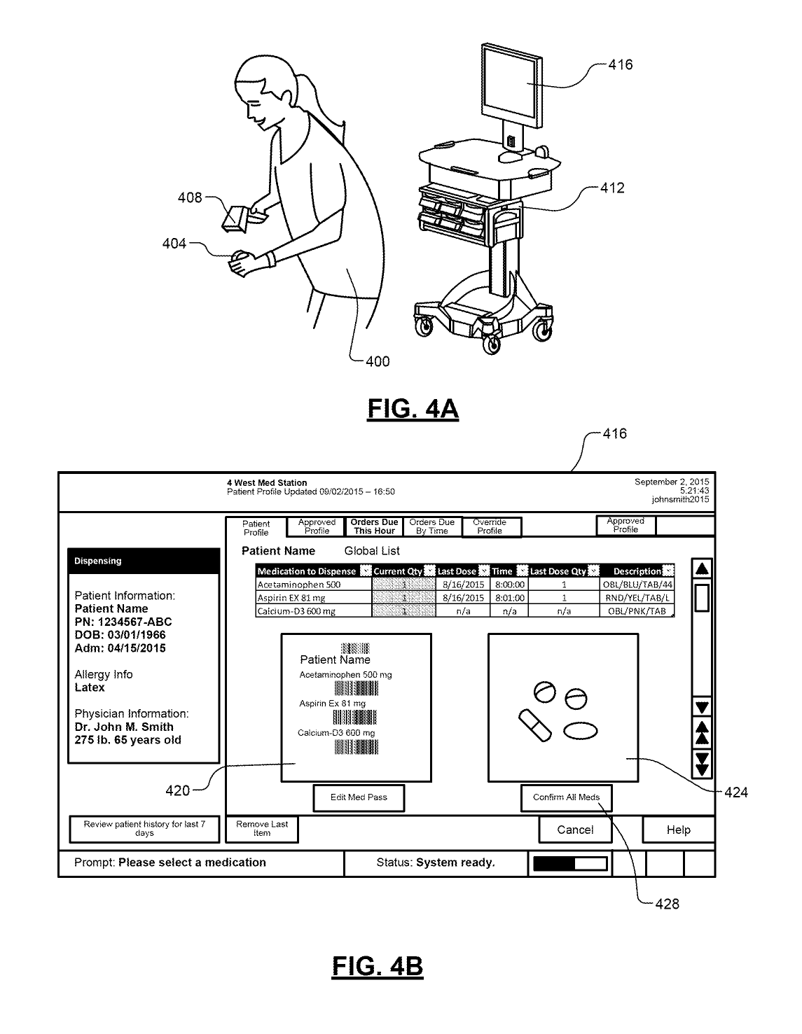

Referring now to FIGS. 4A and 4B, a caregiver 400 is shown scanning a patient wristband 404 with a barcode scanner 408 during administration of a medication. The barcode scanner 408 may be wirelessly connected to a mobile POC workstation 412. The information scanned from the wristband 404 is provided to the workstation 412 to ensure that correct patient is associated with the medications to be administered. For example, scanning the wristband 404 may cause information about the patient to be displayed (e.g., shown on display 416). For example, the information may include, but is not limited to, various medications to be administered to the patient at respective times. The healthcare professional can then select one or more displayed medications, corresponding to the packaged medication (e.g., the medication retrieved from the patient specific drawer 324), to administer to the patient. Or, the healthcare professional may scan a barcode on the package to select the medications to be administered.

Selecting a medication causes the photographs 420 and 424 of the selected medication to be shown on the display 416. For example, the photographs 420 and 424 correspond to both sides of the medication package. The healthcare professional then visually confirms that the medication to be administered matches the photographs 420 and 424, and indicates the confirmation using the display 416. For example, upon confirmation, the healthcare professional may select a “confirm all meds” button 428 on the display 416.

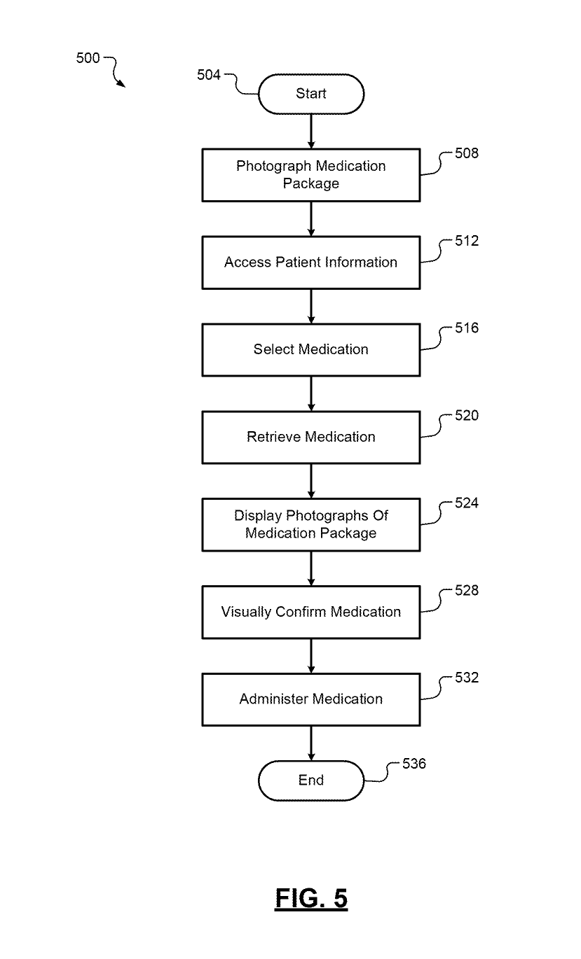

Referring now to FIG. 5, an example medication transportation and verification method 500 begins at 504. At 508, photographs are taken of a medication package and stored in central database. At 512, the healthcare professional accesses information (e.g., at bedside) of a patient. For example, the healthcare professional scans a barcode associated with the patient and information about the patient is provided on a display. At 516, the healthcare professional selects a medication to be administered to the patient. For example, the healthcare professional scans a barcode associated with the medication and/or selects the medication from the display. At 520, a healthcare professional retrieves the medication package from a mobile POC workstation (e.g., a medication package previously transferred from a central pharmacy or a medication base station to the mobile POC workstation) according to a facility-approved protocol. At 524, the photographs of the medication package corresponding to the selected medication are shown on the display. At 528, the healthcare professional visually confirms that the medication package matches the photographs shown on the display. At 532, the healthcare professional administers the medication to the patient. The method 500 ends at 536.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

What is claimed is:

1. A system, comprising:
a database that stores information associated with a patient, wherein the information includes information about at least one medication prescribed to the patient, and that stores at least one photograph of a package containing the medication;
a control module in communication with the database, wherein the control module receives an indication that a healthcare professional has selected the package containing the medication to be administered to the patient and displays the at least one photograph of the package containing the medication, and wherein the control module is configured to receive, from the healthcare professional, confirmation that the at least one photograph matches the package containing the medication as selected to be administered to the patient.

2. The system of claim 1, wherein the at least one photograph includes a photograph of at least two sides of the package containing the medication.

3. The system of claim 1, wherein the at least one photograph includes a transparent side of the package containing the medication.

4. The system of claim 1, further comprising a packager that automatically captures the at least one photograph upon completing packaging of the medication.

5. The system of claim 1, wherein the control module displays the at least one photograph in response to receiving the indication.

6. The system of claim 1, wherein, in response to receiving the indication, the control module (i) displays the at least one photograph and (ii) prompts the healthcare professional to input confirmation that the at least one photograph matches the package containing the medication as selected to be administered to the patient.

7. A system, comprising:
a data storage device that stores information associated with a patient, wherein the information includes information about at least one medication prescribed to the patient, and that stores at least one photograph of a package containing the medication;
a mobile workstation configured to store and/or transport the package containing the medication, the mobile workstation including a control module in communication with the data storage device, wherein
the control module receives an indication that a healthcare professional has selected the package containing the medication to be administered to the patient,
the mobile workstation displays the at least one photograph of the package containing the medication, and
the control module is configured to receive, from the healthcare professional, confirmation that the at least one photograph matches the package containing the medication as selected to be administered to the patient.

8. The system of claim 7, wherein the at least one photograph includes a photograph of at least two sides of the package containing the medication.

9. The system of claim 7, wherein the at least one photograph includes a transparent side of the package containing the medication.

10. The system of claim 7, further comprising a packager that automatically captures the at least one photograph upon completing packaging of the medication.

11. The system of claim 7, wherein the control module displays the at least one photograph in response to receiving the indication.

12. The system of claim 7, wherein, in response to receiving the indication, the control module (i) displays the at least one photograph and (ii) prompts the healthcare professional to input confirmation that the at least one photograph matches the package containing the medication as selected to be administered to the patient.

13. A method, comprising:
storing, in a database, information associated with a patient, wherein the information includes information about at least one medication prescribed to the patient;
storing, in the database, at least one photograph of a package containing the medication;
receiving an indication that a healthcare professional has selected the package containing the medication to be administered to the patient;
displaying the at least one photograph of the package containing the medication; and
receiving, from the healthcare professional, confirmation that the at least one photograph matches the package containing the medication as selected to be administered to the patient.

14. The method of claim 13, wherein the at least one photograph includes a photograph of at least two sides of the package containing the medication.

15. The method of claim 13, wherein the at least one photograph includes a transparent side of the package containing the medication.

16. The method of claim 13, further comprising automatically capturing the at least one photograph upon completing packaging of the medication.

17. The method of claim 13, further comprising displaying the at least one photograph in response to receiving the indication.

18. The method of claim 13, further comprising, in response to receiving the indication, (i) displaying the at least one photograph and (ii) prompting the healthcare professional to input confirmation that the at least one photograph matches the package containing the medication as selected to be administered to the patient.
